(19) United States
(12) Patent Application Publication
(10) Pub. No.: US 2017/0132720 A1
(43) Pub. Date: May 11, 2017

(54) Method for leveraging tax credit eligibility

(71) Applicant: Dean Robert Rehfeld, Glendora, CA (US)

(72) Inventor: Dean Robert Rehfeld, Glendora, CA (US)

(21) Appl. No.: 14/998,034

(22) Filed: Mar. 24, 2015

(51) Int. Cl. G06Q 40/00; G06Q 10/10

(52) U.S. Cl. CPC G06Q 40/123; G06Q 10/1053

(57) ABSTRACT

A method and system for leveraging tax credit eligibility is disclosed. An embodiment provides a tax credit screening survey to job seekers, who may screen themselves for tax credit eligibility, obtain documentation, demonstrate tax credit eligibility, etc., to a plurality of potential employers—leveraging their tax credit eligibility. If job seekers do not currently qualify, an embodiment informs them on how they might qualify. Embodiments track eligibility and prompt the job seeker to see if they have become qualified or unqualified. Tax credit eligibility becomes public knowledge. Job seekers view which employers are looking to hire job credit eligible workers. An embodiment provides employers with a database of pre-screened job seekers with tax credit eligibility documentation, allowing employers to shop for job seekers based on tax credit status. The disclosed embodiment may used as its own system, applied to a social network, integrated with a job board, etc. Employers have an openly accessible, social networking, internet model; they can sign up for, purchase, and utilize this program online. With this viral/social, fully web-enabled model, an embodiment takes advantage of alternative revenue generation. Job seekers are incentivized to stay employed and max out the credit. Automated pre-screening increases screening accuracy by accessing social media profiles to generate a customized, smart, adaptive survey for job seekers.

### INCORPORATE FOR REFERENCE THE WEBSITES

https://myjobcredit.com/; https://drakesjobs.com/

### BACKGROUND OF THE INVENTION

### Description of Related Art

Multiple levels of government offer monetary incentives to employers that hire individuals from disadvantaged groups. For example, employers receive incentives in the form of tax credits for hiring veterans, food stamp recipients, residents of depressed areas, etc. The intent of employment tax credits is for disadvantaged people to find employment. Tax credit eligibility screening is either done by the employer or by a tax credit services provider. Tax credit screening currently happens at either the point of application or the point of hire. This allows employers to receive credits and tax credit providers to profit from processing the tax credits, because the screening process is tied to an individual employer. Current screening tools do not inform the job seeker that they are tax credit qualified. For example, see patent application Ser. No. 10/339,901, FIG. 8H and/or FIG. 8I: only the employer knows whether the applicant qualifies.

Other tax credit screening systems are backward. They benefit the employer—not the job seeker. Job seekers cannot freely and/or easily take advantage of their tax credit eligibility. Other tax credit screening processes do not empower the job seeker to leverage their tax credit potential to find employment with any employer of the job seeker's choosing. Other tax credit processors safeguard tax credit screening as a private system with the employer as the main client: tax credit eligibility is not public knowledge. The screening tools of other providers are only available to paying clients: no current provider offers screening tools to job seekers.

In view of the previous problems, it would be beneficial if there were a screening tool that was an openly accessible, independent, web application. A social media solution does not exist: job seekers are not able to share a tool with other people, helping others benefit from tax credits. Further, with other solutions, job seekers do not know if they qualify for a tax credit and are unable to find out what they can do to qualify for a tax credit. Job seekers also do not know which employers are seeking tax credit eligible job seekers; further, job seekers do not have the opportunity to share their eligibility with any employer—or many employers—of their choosing. Tax credit eligibility cannot be leveraged in applying for any job—or many jobs—via integration with a job board, as a job board itself, as social media, etc. Other models do not allow for tax credit planning on the part of the employer. A searchable pool of potentially eligible tax credit job seekers or companies seeking these job seekers does not exist. The screening process for eligibility would be more accurate if job seekers were assisted with a scientific method to uncover their eligibility—instead of relying on self-reporting. Current models do not allow for staffing partners to leverage tax credits by inviting job seekers and connecting them to employers. To maximize a tax credit, employees must stay with a company for a certain number of hours: current models do not provide an incentive to employees to maximize the credit.

Existing systems do not take advantage of the opportunities of the social web for distributing and utilizing tax credits. They do not give job seekers the opportunity to know their own eligibility or give them access to a pool of employers seeking tax credit eligible employees. Also, they do not provide a pool of eligible job seekers to employers. Additionally, they do not provide control of tax credit processing for employers. No existing system enables staffing partners to invite job seekers to screen themselves and/or connect with employers; staffing partners also invite employers. Existing systems do not integrate tax credit screening with job boards. Existing systems do not work well, because they are outdated in their operating methods and do not take advantage of the opportunities of social media/networking to connect job seekers, employers, and staffing partners. Existing systems are not openly accessible to the internet community or self-service; they are not social/viral; current screening processes are not as accurate as they could be, because they do not utilize social media profiles (Facebook, Google+) to personalize the survey, and existing surveys rely on self-reporting by the job seeker.

An embodiment is a platform for open connection of tax credit eligible job seekers with employers. Connecting to a job board, an embodiment can allow job seekers to screen themselves for tax credit eligibility and leverage their status in applying to employers; employers can recruit job seekers based on their eligibility. An embodiment can pursue job seekers as clients—regardless of the employer—and allows free, open access to the platform: tax credit eligibility is public knowledge. Job seekers are able to screen themselves prior to applying for a job and receive documentation about their potential tax credit eligibility status—whether the job seeker eventually applies to an employer that is a client or not. If they don't currently qualify, an embodiment informs them on how they might qualify. An embodiment tracks eligibility and prompts the job seeker to see if they have become qualified. Job seekers also view which employers are looking to hire tax credit eligible workers. Documentation, which demonstrates eligibility status, can be sent to any employer; employers can act on said documentation by hiring the job seeker and utilizing the credit. Employers have an openly accessible, social networking, internet model; they can sign up for, purchase, and utilize this program online. With this viral/social, fully web-enabled model, an embodiment can take advantage of alternative revenue generation and provides much, if not all, of the services at no cost—through ads, freemium, etc. An embodiment can allow live access for management, processing, reporting, and tax credit planning: users can sort credit by type (federal, state, etc.) and dollar amount. Employers can access a hiring pool of potentially eligible job seekers. Job seekers can be incentivized to stay employed and max out the credit and can earn more incentives with hashtags, check-ins, sharing, liking, etc. An automated pre-screening system increases screening accuracy by accessing social media profiles to generate a customized, smart, adaptive survey, extracting answers to survey questions to avoid self-reporting. Further, job seekers are presented with the custom survey that avoids difficult wording. The social media aspect allows an embodiment to be shared, liked, and integrated with the viral web. Staffing partners (public/private career services, training, education entities, etc.) can use an embodiment to connect job seekers with employers.

Job seekers can screen themselves for tax credit eligibility and demonstrate this eligibility to any employer. An embodiment provides employers with more tax credits by giving them access to a pool of tax credit eligible job seekers. Job seekers are better prepared to obtain a job by leveraging the power of their tax credit eligibility status documentation. An embodiment has a unique viral distribution model, because the site connects to social media (share, liking, Facebook, etc.), and the job seeker is encouraged to share their eligibility documentation openly. An automated pre-screening API creates a personalized, adaptive screening survey that is more accurate—resulting in a larger pool of eligible employees. An embodiment provides a platform that staffing partners can utilize to connect job seekers and employers. Self-processing allows employers to process their own credits with an openly accessible, internet model through web-based tools. An embodiment is the only tax credit screening and processing solution that can be fully integrated or connected to job boards.

An embodiment evolves tax credit processing with current technology through its viral distribution model that utilizes social media and mobile accessibility. It gives job seekers the knowledge and power to screen themselves and leverage their tax credit status with their documentation; or, they are informed about how they can become qualified; an embodiment can provide employers with more tax credits by accessing a pool of potentially eligible employees; an embodiment provides the ease of creating an account with the user's social media profile (Facebook login); automated pre-screening personalizes the screening surveys by accessing social media to make them easier to use and smarter; this increases understanding of job seekers, which improves screening accuracy and the volume of high potential job seekers; staffing partners also utilize an embodiment to connect job seekers and employers. Further, an embodiment gives employers control of their tax credits—allowing employers to process their own tax credits; an embodiment provides real-time information about their credits. An embodiment connects employers and job seekers, both of which can capitalize on tax credits. Eligibility documentation gives job seekers documentation about their eligibility that they can send to any employer, and the employer can hire the job seeker to take advantage of the credit. Hired employees are incentivized to remain employed and maximize the credit. Sharing their documentation on social media creates the viral distribution and revenue model that eliminates costs to users; users are incentivized to facilitate this viral model (hashtags, sharing, liking, etc). Uniquely, staffing partners can use an embodiment as a part of their goal to improve placements rates for job seekers, and they contribute to the pool by adding more employers and job seekers. An embodiment provides sharing tax credit data with job boards, so that tax credit eligibility can be used in applying to any company and employers can search for job seekers

Some important elements of an embodiment are the ability for a job seeker to screen themselves, be provided with documentation, and be part of the hiring pool. There has never been a platform that utilizes the power of social media, which so many job seekers utilize in today's world. An embodiment creates a relationship where key stakeholders can meet to find and fill jobs with tax credit eligible job seekers (job seekers, employers, staffing partners). Especially notable are the social media compatibility, Facebook survey/app, job seeker and employer job boards, user profiles, automated pre-screening API (including—but not limited to—assisting the job seeker in giving correct, qualifying answers), self-service processing, documentation, informing the user on how they can become qualified, providing a bonus to job seekers that gain employment, incentivizing job seekers to maximize credits, staffing partner integration, hiring pool, integration with job boards, open-internet-model, etc.

### Relationship Between the Components

MyJobCredit.com is an embodiment website that users access. The survey is accessed by job seekers to determine their tax credit eligibility status. A program dictates the content of the survey: it accesses the job seeker's social media profile (Facebook, Google+, etc) to generate a personalized survey experience and webpage. It generates the survey with different questions if the job seeker opts not to sign in with a social media profile. Data about users is utilized to generate the survey—whether from social media or not). A documentation page informs the job seeker about the results of their survey—either they qualify and receive documentation, or they are informed about what conditions should be satisfied in order for the user to become qualified, or they do not qualify at this time. Job seekers can supply documentation to the employer as proof of their potential eligibility status. This is also one of the social aspects of an embodiment—the user can share or like their documentation on social media to inform others about their tax credit opportunity. If the job seeker does not log in with a social media profile, they will be prompted to create a job seeker profile by populating the appropriate fields. Social media users will also complete the job seeker profile by logging in.

An embodiment hiring pool is a database that employers are able to search for tax credit eligible job seekers. Self-processing is an additional tool for employers that allows them to manage their job seekers and employees, view their credit status, manage their credits, and/or process their own credits in real-time. An embodiment provides staffing partners invite job seekers to take the survey and invite employers to join an embodiment—connecting job seekers and employers. An embodiment survey can be accessed via a social media app embodiment, so that job seekers can seamlessly sign in, take the survey, and share their results. An embodiment is a responsive site that allows access from different devices (desktop, phones, tablets, etc.).

### How Components Work Together

Users (job seekers, employers, and staffing partner) can enter an embodiment from these locations: direct URL, a job site, an app, through a social media site (e.g., Facebook survey app), etc. An embodiment site is responsive and viewable from any device. The user role selected determines the pages displayed. An embodiment contains advertising, generating revenue and providing free access. Users are prompted to login with social media (Facebook, etc.), create a profile, etc. Current location identifier determines the job seeker's location (e.g., GPS for mobile devices) or presents the option to enter a zip code to determine the content of the survey. An embodiment job seeker profile has any number of these features: activity, recommended employers, recommended job postings, job search, saved jobs, sign up for job alerts, documentation access/update, share, earn, & redeem program, education, experience, skills, references, picture, following, and social media buttons. Job seeker can use an embodiment to track hours to maximize credits and receive the bonus, interact with social media, earn & redeem points, be visible to employers/staffing partners and can connect with them, apply for jobs, screen for credits, and send results. An embodiment of the employer profile has any number of these features: activity, picture, hiring pool, top eligible job seekers, posted jobs, post a new job, job archive, job seekers following, job seekers, employees, credit reporting, social media buttons, live billing, staffing partners, self-processing, and share, earn & redeem. An embodiment provides employers credit results, find and hire job seekers to maximize their credits, invite and connect with job seekers and staffing partners, pay online, post jobs, process credits, earn & redeem points, credit reporting and planning, connect with social media, etc. An embodiment staffing partner profile has any number of these features: activity, picture, post jobs, jobs archive, following, reports on job seekers, job seekers, employers, etc. An embodiment staffing partners can invite and connect with job seekers and employers, post jobs, access reporting, connect with social media, maximize their placement records, etc.

A plurality of users have the capability to share, earn, redeem, etc. In an embodiment, particular actions (e.g., sharing, liking, hashtags) determine the points earned. Users can redeem points on an embodiment. A tax credit qualification survey embodiment steps the job seeker's through questions to determine if they qualify for tax credits. An automated process customizes the survey questions given to the user by accessing the user's social media profile—education, work history, location, gender, age, etc. A survey embodiment uses stepped logic by asking the minimal amount of questions needed so that the user experience is streamlined: e.g., if the user is 30 days away from being qualified, the backend tracks and notifies the job seeker when he/she is close to qualification, asking him/her to update the survey to determine qualification/credit amount. A plurality of embodiments assist the user in providing correct, qualifying answers. After the user submits their answers, an engine embodiment identifies eligibility according to a plurality of statuses, which may include the some or all of the following phrases to similar or identical meaning: does not qualify, so close to qualification, high potential qualification. Documentation embodiments enable job seekers to illustrate tax credit potential to employers. Documentation may include a personal identification number (PIN), so employers can look up a job seeker on the site. Job seekers may have the ability to access or update their documentation. An embodiment of documentation may have this information: tax credit amount, tax credit type, name, instructions for job seekers and employers, PIN, send, download, email, print buttons, etc. Users may have ability to view, print, send to employers, email documentation, etc. An embodiment allows users to transfer their profiles from job boards and take tax credit eligibility back to the job board or social media profile to leverage eligibility as they apply for a job. Job seekers can also choose to screen themselves on an embodiment and then place themselves onto other job boards or third-party sites.

### How to Make the Invention

Knowledge of the social web is important: e.g., how people use the web, search, enter information, share, like, etc. One should have knowledge of tax credit programs and regulations: these regulations vary between localities and states. One should have knowledge of the way employers want to access/utilize these programs, including the type of credit and the credit value. One should have knowledge of how to design and build websites and make them commercially viable/scalable.

These core aspects make a plurality of embodiments unique: social networking, an independent, open-access website—uniquely applied to a tax credit solution. An embodiment capitalizes on the functions of social networking and job sites to include the power of tax credits. Tax credit screening survey app embodiment replicates the simplicity and viral distribution of quick social media surveys. Uniquely, an embodiment seeks job seekers in the tax credit process. Social media integration—similar to any website that interacts with social media, an embodiment is viral and interactive. Documentation simplifies the screening process, makes the message simple/communicable, and facilitates demonstrating this information. The value of documentation is easily understood and distributed virally: the job seeker gains power over tax credits. A viral aspect of an embodiment includes incentivizing users to broadcast their interaction with an embodiment on social media: users earn points they can redeem on an embodiment. Job seekers earn incentives by getting a job, and they earn more money by maximizing the credit: this is unique to a plurality of embodiments. Leveraging website APIs to capture information from social media profiles to automatically generate a personalized survey; e.g., if the user is male/straight, information videos display attractive females; if user's language is Spanish, the questions are automatically in Spanish, etc. Job board integration—communicating tax credit eligibility, leveraging eligibility in applying for jobs, and sharing job seeker profiles.

### How to Use the Invention

Job seekers can discover their eligibility status and provide documentation. If a job seeker does not qualify, an embodiment informs them on how to become qualified. Documentation empowers job seekers in their search for employment. Job seekers may be better screened for their eligibility as a result of the smart survey generation. Job seekers can then connect to employers through searchable pools of employers that are looking for tax credit eligible workers—sending results within an embodiment. Job seekers can receive points for utilizing the social aspects of an embodiment and may be able to redeem them on the site in an embodiment. Users can help others benefit from tax credits through social media. An embodiment incentivizes job seekers to get hired and maximize their credit. Employers can choose who they want to interview not only based on their education or experience but also their tax credit eligibility status. Employers pick from a database of eligible job seekers, instead of waiting to screen people as they apply or hire. Employers may pick from a larger and more accurate group of job seekers as a result of automated pre-screening. Employers may also choose by type and credit amount. Employers may also be able to post jobs for documentation holders on an embodiment. Employers can use an embodiment to process tax credits on their own or to outsource the service to an embodiment. Employers are able to view and maintain their tax credits status online and in real-time; this streamlines the process and saves employers money. This process gives employers the advantage of “tax credit planning”, allowing employers to maximize their tax credits. Employers can also capture a job seeker's results and send them to the tax credit processor of their choice. Employers may also utilize the “Share, Earn, & Redeem” program. Staffing partners may use the tool to connect job seekers and employers as they contribute to the employer and job seeker pools. If coming from a job board, job seekers can screen themselves for eligibility and take this information back to the other site.

Any number of parts of an embodiment are critical to its success, but each and all could be utilized separately and should be protected. Automated pre-screening is a unique tool that can be applied to how any other survey is generated. The pre-screening process of an embodiment is generated by the site, but could be applied outside our system and belongs to an embodiment; additionally, the idea of having searchable pools that connect potentially eligible job seekers and employers is an idea belonging to an embodiment, including the integration of staffing partners. Having documentation regarding one's tax credit eligibility status to present to a potential employer is unique to an embodiment. The ability to send your survey results to any employer—further, any email address, social network, etc.—is our idea and should not be used by another company. Incentives to get hired and maximize a credit should not be copied by other providers. Branding, badging, certifying, or labeling a job seeker as being pre-qualified for a tax credit could be used on other sites and should not be copied. A responsive site (mobile) for social tax credits could be applied similarly and should be included in this patent. The viral distribution of this tax credit solution should not be copied elsewhere—this includes the social media plugin, Share, Earn, and Redeem, Facebook survey, documentation, etc. The hiring pool of eligible job seekers is unique to an embodiment—the ability to ‘shop’ for pre-screened job seekers. The concept of telling a job seeker what they can do to become eligible for a tax credit is ours and should not be used by another company. The free, do-it-yourself model derives revenue from a plurality of models—no other tax credit company makes money in this way. Existing companies do not provide the tools for tax credit planning—displaying the different types of credits and their dollar amounts. Additional revenue is created when employers capture a job seeker's survey results and send them to another tax credit company.

A program customizes the qualification survey based on if-then relationships: if the user is male, then they can get survey 1; if the user is female, they may get survey 2, etc. The survey itself can present questions based on previous answers: if the user says they are a veteran, they are then asked if they have a service-connected disability. The program helps the user become qualified: if a user says they have been on SNAP 5 months, but 6 months will qualify them, the survey can respond with “are you sure?”—in hopes that the job seeker will select the answers required for qualification. The survey results are the product of the answers given: documentation, so close, not qualified. Further, the stipulations given to tell the job seeker how to become qualified are relative to the answers: e.g., stay on SNAP for one more month. Job seekers may be given many options for distributing their results: print, email, send to employer; what follows is relative to their selection. Employers may search for credits and sort them by type, dollar amount, and location.

### BRIEF DESCRIPTION OF THE FIGURES

FIG. 1 is a flowchart of an embodiment, depicting a job seeker's role in an embodiment. FIG. 1 depicts how a job seeker initializes tax credit screening through an open, web application and uses their tax credit eligibility to connect with employers and find employment

FIG. 2 is a flowchart depicting an embodiment of how a job seeker connects tax credits with social media or other mass communication forms. FIG. 2 depicts a plurality of job seekers distributing their tax credit eligibility in applying for employment, connecting with employers, adding tax credit eligibility to a profile on another site, broadcasting on social media, etc. Other users follow a similar embodiment to share tax credit information, earn points, redeem the points, etc.

FIG. 3 is a flowchart depicting an embodiment of tax credit screening applied to a job board. Job seekers apply to multiple jobs using tax credit eligibility. Employers receive applications from pre-screened job seekers and browse pre-screened job seekers.

FIG. 4 is a flowchart depiction of an embodiment of tax credit screening applied to social networking/social media.

FIG. 5 is a flowchart depiction of an embodiment of employers connecting with pre-screened job seekers via a database. FIG. 5 also demonstrates how the different users connect.

FIG. 6 is a flowchart depiction of an embodiment of an employer profile. The employer profile is an embodiment of how employers connect with job seekers and staffing partners.

FIG. 7 is a flowchart depiction of an embodiment of a staffing partner profile. The staffing partner profile is an embodiment of how staffing partners connect with job seekers and employers.

FIG. 8 depicts several embodiments of how a tax credit screening program informs a job seeker about their tax credit eligibility, advises a job seeker on how to become qualified for a tax credit, and produces documentation for the job seeker to demonstrate their tax credit eligibility.

FIG. 9 and FIG. 10 depicts a plurality of embodiments of how a tax credit screening system produces customized surveys based on the job seeker's information, whether it is accessed from social media or social networking or location identifier or other means.

### DETAILED DESCRIPTION OF EMBODIMENTS

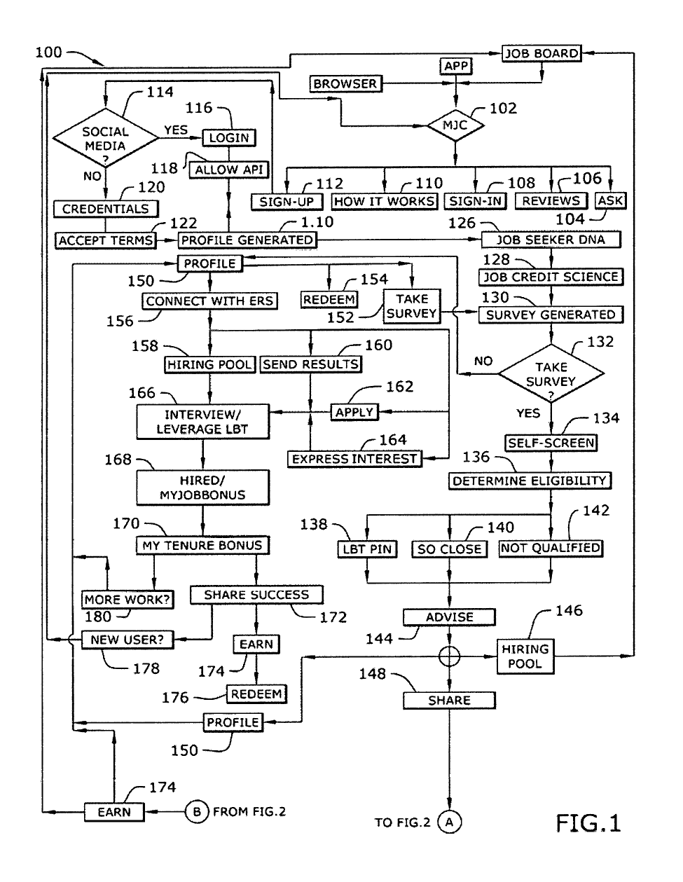

### FIG. 1-100

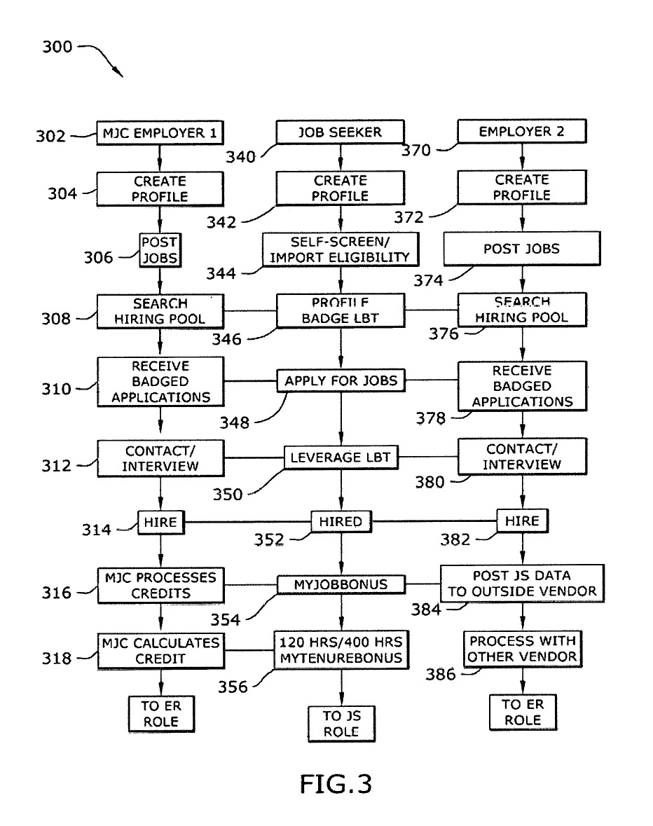

FIG. 1 is a flowchart of an embodiment, depicting user roles. FIG. 1 depicts a job seeker initializing tax credit screening through an embodiment—independent, open, web application, etc.—using their tax credit eligibility to connect with employers and find employment. BROWSER, APP, JOB BOARD depicts some network interfaces to access an embodiment 102 in some embodiments. BROWSER references an embodiment of an independent, open, web application that can be accessed via a web browser on a personal computer, a phone with internet access, a tablet, any other device or machine capable of accessing the internet, etc. APP depicts an embodiment as a mobile application, a smartphone application, a tablet application, other application for devices, etc. A plurality of the same, similar, related, some, all, a single, etc., of the operations available on the web browser are utilized on an app embodiment. JOB BOARD depicts an embodiment wherein an embodiment is a ‘bolt-on’ or ‘plug-in’ or ‘API’ and/or etc., utilized by third-party sites for tax credit screening, tax credit utilization, etc. An embodiment stands alone as its own tax credit/social networking site, but it may also work as a tax credit screening, processing tool for job boards, job searching sites, recruiting sites, social networks, ATSs, etc., as depicted. As depicted in FIG. 1, an embodiment contains and/or is a job board where job seekers take advantage of screening themselves for a tax credit—perhaps while applying for a job. If a user were on a separate, third-party job board, they could use an embodiment to screen themselves for a tax credit and be able to add documentation of their tax credit eligibility to their application and/or profile. Employers on third-party sites can find job seekers with their tax credit value. Tax credit screening that is attached to, bolted on, integrated with, part of, in any way applied to a job board, etc., is further demonstrated in FIG. 3.

In FIG. 1, MJC 102 can refer to an embodiment independent, open, web application, user interface, etc., accessed by a user in this embodiment. Ask 104 refers to a webpage where users can ask questions regarding how to use this embodiment to screen for tax credit eligibility, leverage this eligibility, process the credits, anything related to tax credits, this embodiment, etc. The mechanism of communication could be a forum, live chat, email submission, social media networking integration, other means of network communication, etc. Reviews 106 references a webpage where users communicate the value of tax credit eligibility with each other. In this embodiment, 106 includes an interface for users to post text, videos, images, other communication means, etc., regarding the advantages of tax credit eligibility. Sign-in 108 references how a registered user would access their profile. How it works 110 refers to a webpage where users—in this embodiment, job seekers—learn about how to screen themselves for tax credit eligibility, take advantage of their eligibility, etc., in finding employment. Sign up 112 refers to a webpage where any internet user with access to a web browser, application, etc., can sign-up, create a profile, implement, use, etc., the services online. After a user—in this embodiment, a job seeker—selects social media 114 sign-up, the user is presented with the option of creating a profile using information acquired by accessing the application programming interface (henceforth, API) of a third-party site where said user has an existing profile. In this embodiment, the user accesses their social media, social networking profile, etc. This might refer to Facebook®, Twitter®, Google+®, Instagram®, etc. If a user opts to login 116 with social media, the setup process becomes automated, and the user's login credentials are that of the third-party site. The user may not have to manually enter data.

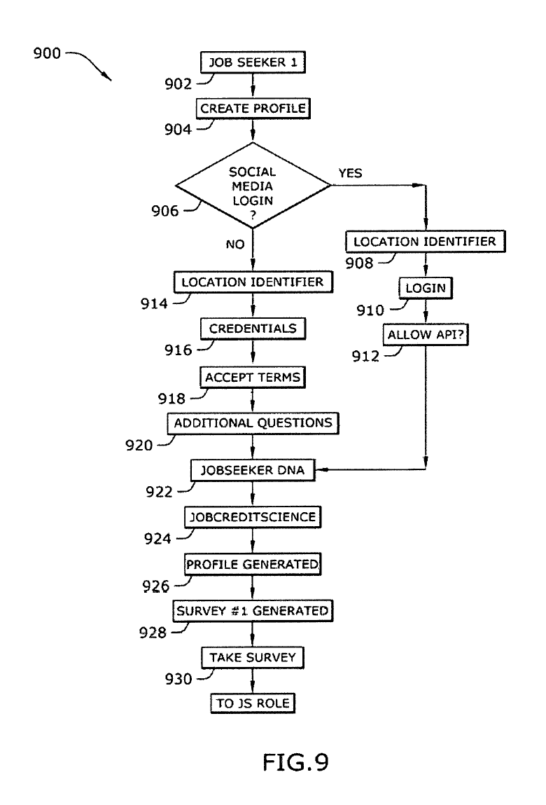

As shown in FIG. 1, when a user chooses, selects to login, etc., with social media network, a job board profile, another outside profile with similar information, etc., the user may be presented with a screen to verify that an embodiment MJC can access the user's API, 118, from the user's profile on the third-party site. The job seeker might allow an embodiment MJC to access user's public profile information, including, but not limited to: name, picture, location, interests, education, likes, language, description, biographical data, etc. By allowing API access, the user might also commit to the relevant terms & conditions of using an embodiment MJC. This is further referenced in FIGS. 9 & 10. If a user chooses not to login with a social network profile, then the user is presented with a traditional create profile situation. The user adds relevant profile credentials, 120, manually—via a keyboard, typing, virtual keyboard, texting keyboard, other interface, etc., that allows for inserting alphabetic, numeric, symbolic figures, etc. In this embodiment, a user accepts the terms 122 and conditions of accessing the site.

In this embodiment shown in FIG. 1, after creating a profile from either the traditional, 112, social network API, job board API routes, 114, etc., An embodiment MJC generates the user profile 124. Whenever any user returns to an embodiment MJC and logs in via the sign-in webpage, 108, the user is taken to their profile. Certain information, 126, regarding a job seeker is relevant to creating a customized tax credit eligibility survey and/or for determining tax credit eligibility. Relevant information 126 might include, the job seeker's location, language, education, employment, likes, interests, military history, disability, etc. In this embodiment, the information, 126, acquired from the create profile mechanisms that is stored is referred to as JobSeekerDNA. The information could be referenced differently in other embodiments. In this embodiment, JobCreditScience 128 refers to a program, system, algorithm, any means to generate a custom survey, etc., based on the job seeker's information. Data points from 126 inform the content of the survey. For example, if the user has Spanish listed as their language on their social media profile, 128 will automatically generate a Spanish language survey. If the user is located in California, 128 will give the user questions that relate to employment in California. Assistance, information, advice, etc., accompanying the survey is also custom to the job seeker. For example, if the job seeker is a male interested in women, the help videos on the side of the survey will be of an attractive female. 128 could be applied as a survey in many different embodiments. This is further demonstrated in FIGS. 9 & 10. 128 produces a custom survey 130 for the job seeker based on 126. This is further demonstrated in FIGS. 9 & 10.

In FIG. 1, after a job seeker has created a profile, 112 or 114, and an embodiment of MJC has produced the survey, the user is presented with the option to take the survey immediately or go to their profile. In this embodiment, the job seeker has the ability to initiate the screening themselves, SELF-SCREEN 134, primarily for their own purposes. The survey asks questions related to tax credit eligibility in a step-logic fashion. Depending on how the user answers the questions, the user will be asked more or less questions. The answers then indicate tax credit potential. In another embodiment, the survey is part of a Facebook® app or social media or network or third-party survey. An embodiment of MJC determines what the user's tax credit potential, 136, by assessing the answers to their questions, the JobSeekerDNA 126, etc.

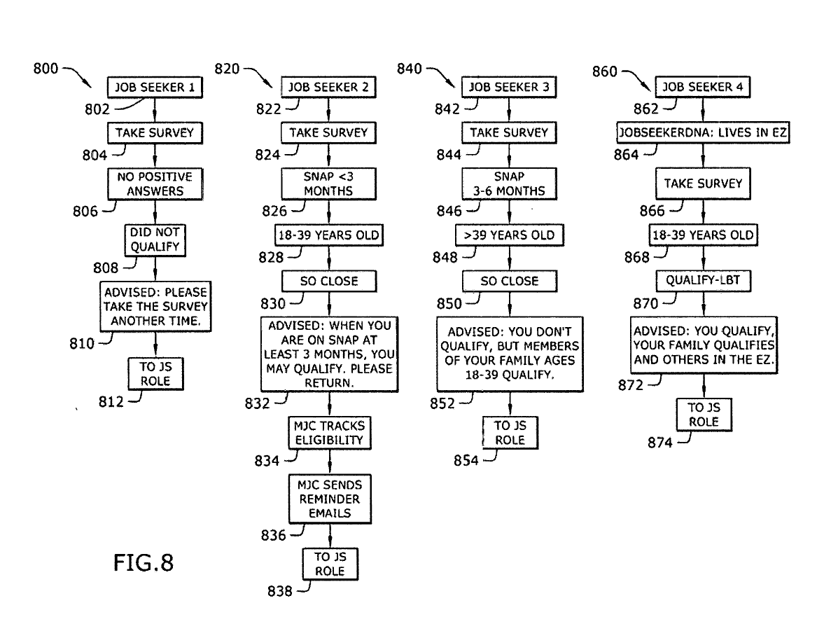

In this embodiment shown in FIG. 1, the job seeker is presented the job seeker's survey results 138. A user that qualifies for a tax credit is given a LittleBlueTicket (LBT) 138 with or without a unique PIN as part of the documentation of the job seeker's tax credit eligibility. In other embodiments, this documentation 138 could take other forms. The LBT is documentation 138 for the job seekers to demonstrate their tax credit potential to prospective employers. The LBT displays a plurality of information related to tax credit eligibility that might include the amount of money that the job seeker is worth, information about the specific tax credit, the tax credit authority or zone—state, WOTC, etc.—and information for the employer on how to take advantage of the credit. An embodiment of the LBT includes a unique PIN number that can be given to employers, directing them to the job seeker's an embodiment of an embodiment of an embodiment of MJC profile, etc. In this embodiment, the job seeker can print, email, download, attach, capture, otherwise obtain the LBT documentation, etc., to distribute to employers of the job seeker's choosing. The job seeker is encouraged to share their LBT with others via email, social media, other means, etc. The job seeker is encouraged to utilize their LBT in applying for a job. The job seeker is encouraged to refer their family and/or friends and/or neighbors and/or others to an embodiment of MJC to take advantage of tax credit eligibility. This is further demonstrated in FIG. 8.

In an embodiment, the job seeker is presented with the job seeker's survey results 140. In this embodiment, as shown in FIG. 1, if the job seeker's JobSeekerDNA 126 and/or the answers that the job seeker supplied in the survey indicate that the job seekers does not currently qualify for a tax credit but is close to being qualified, the job seeker is presented with a ‘so close’ results page 140. For example, if a user has been on SNAP for 2 months, the job seeker is informed that they will be qualified for a tax credit if they receive SNAP for 1 more month. In an embodiment MJC, an embodiment informs the job seeker what they should do in order to become qualified for a tax credit, 140. The job seeker is encouraged to utilize tax credits and share an embodiment with others, 140. This is further demonstrated in FIG. 8.

In this embodiment in FIG. 1, the job seeker is presented with the job seeker's results to the survey 142. If the job seeker's JobSeekerDNA, 126, the answers to the survey, etc., do not indicate tax credit eligibility, and they are not ‘So Close’, 140, then they are informed of their ineligibility, advised on what stipulations qualify someone for a tax credit or how others might qualify, etc. See FIG. 8.

As referenced in 140, 141, and 142, regardless of the user's tax eligibility, ineligibility, etc., the job seeker is advised 144 on what they can do to take advantage of their status, an embodiment of MJC program, etc., including, but not limited to: if the user qualifies, the user is encouraged to take their LBT to prospective employers 144, in this embodiment; if the user is ‘so close’, the user is informed on how to become qualified 144, in this embodiment; if the user does not qualify, the user is advised to use an embodiment in their job hunt, express interest to employers 144, etc., in this embodiment. See FIG. 8.

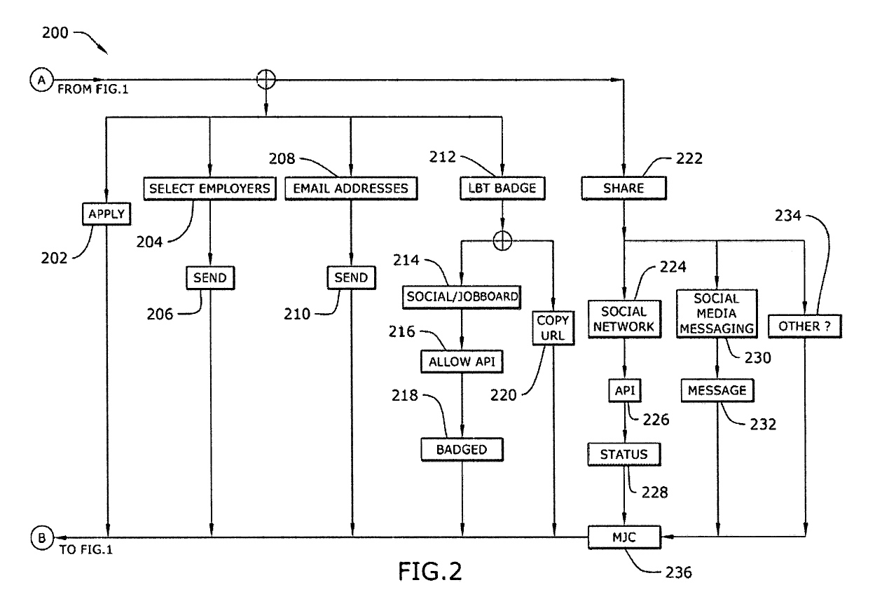

In this embodiment, on the results pages 140, 141, 142, etc., the user is presented with an option mechanism 146 to share their results. Clicking share will give the user options to share, social network, send, email, apply, capture, attach, etc., via the steps outline in FIG. 2, 200-236.

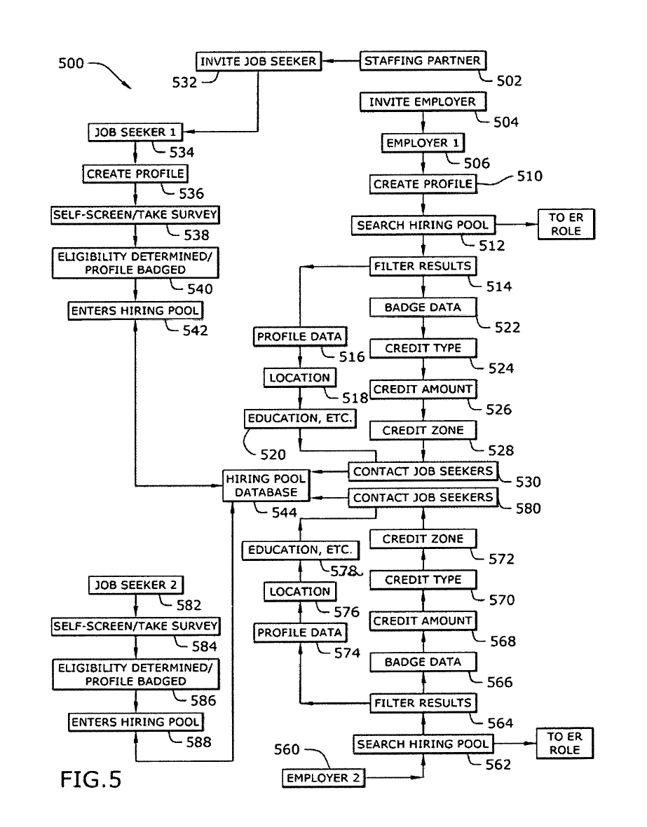

In this embodiment, on the results screens 140, 141, 142, etc., there is a toggle as to whether the user would like to become part of the Hiring Pool 148. In this embodiment, the ‘Hiring Pool’ references an interface that stores, presents, displays, distributes by another method, etc., a list, a database, a memory, etc., comprising a plurality of job seekers with tax credit eligibility information—whether the job seekers are qualified or not, the value of the credit, the governing authority of the credit, the geographic location of the credit, etc. In this embodiment, the toggle is set to ‘yes’ (add to Hiring Pool 148) by default. 148 is where job seekers make themselves visible to potential employers, in an embodiment. This feature allows employers to ‘shop’ for job seekers, not just based off of their education or experience, etc., but most importantly to an embodiment of MJC, their tax credit potential—140, 141, 142. In an embodiment, tax credit potential is visible to employers, employers can search by tax credit type (state, federal, WOTC, etc.), amount ($2,400, $9,000, etc.), etc. Employers can ‘add’, ‘follow’, ‘express interest’, contact, similar function, etc., the job seekers that they might be interested in employing. If an employer wants to hire a job seeker and process their tax credit with a company outside an embodiment, they can take the job seeker's credit data—140, 141, 142—personal information, 126, etc., to another company and/or website. In another embodiment, the job seeker opts to be added to one or a plurality of other job board's similar embodiment of the hiring pool(s) 148. The arrow from 146 to JOB BOARD references a data flow of user information to a third-party site, the job seeker returning to the JOB BOARD website, any other third-party communication with an embodiment, etc., regarding a user's tax credit information. See FIG. 5.

In this embodiment, whether the job seeker does or does not share their results, whether they do or do not enter the hiring pool, the user can go to their profile 150. In this embodiment, the user profile 150 is similar to √a social media profile or a job board profile. The profile contains information about the user, including, but not limited to: skills, experience, education, references, location, profile picture, tax credit potential, etc. The profile allows the user to explore job opportunities, express interest in employment, etc. The job seeker profile 150 can be accessed at any time, from any web browser, a smartphone application embodiment, etc., by the user. Prospective employers may view job seeker profiles via the hiring pool or the unique PIN or another means, etc. Staffing partners may connect with job seekers via the job seeker profile 150; they can invite job seekers to join an embodiment, connect them with employers, distribute job postings to them, etc. If the employer wants to hire the job seeker but wants to process with their own tax credit provider, they are able to take the data from an embodiment to their preferred vendor.

In an embodiment, if a job seeker has created an account, 112 and/or 114, etc., but has not taken the survey, a job seeker can choose to take the survey 152 from their profile 150, in an embodiment. Or if they are retaking the survey, it can also be accessed from the profile 150, in an embodiment. Job seekers can return to retake the survey to see if they have become qualified. For example, if they are ‘so close’. See FIG. 8.

In an embodiment, job seekers can redeem 154 the points that they have earned via a plurality of methods, such as sharing their results, sending their results, applying to jobs, maximizing a credit, etc. The points might refer to monetary value, may be exchanged for items, prizes, etc.

The job seeker can use their profile to connect with employers 156, leveraging their tax credit eligibility to find employment. The job seeker might select from a list of employers, message them, communicate with them, etc. As referenced in 146, a plurality of job seeker profiles are located in a memory that could be viewable and/or searchable and/or sortable by employers. The hiring pool 158 might also refer to a job seeker adding themselves and their credit eligibility to a third-party job board. The job seeker can choose whether to be available to other users in the hiring pool 158, 146, etc.

In this embodiment, the job seeker can choose to send their results, 160, to any employer and/or email address and/or via a third-party job board and/or social media site, etc. The employers might be selected if they are registered users of an embodiment MJC and/or there might a blank input field, etc., for entering an email address of the job seeker's choosing and/or there may be the option of sending the results via social media, etc. Any such mechanism for distributing such information should be considered viable for sending results 160.

In this embodiment, a job seeker can apply directly 162 to employers of their own choosing that might be affiliated with an embodiment and/or might be partnered via a third-party site. As part of their job application, the job seeker has the option of including their tax credit eligibility information—140, 141, 142.

In this embodiment, a job seeker can ‘Express Interest’ to an employer 164. This is a sort of ‘nudge’ to an employer that the job seeker exists and is interested in being employed by the company and may or may not include tax credit eligibility information. The employer may receive a notification and/or an alert and/or an email and/or a similar communication that the job seeker is interested in employment.

A job seeker can be interviewed by the employer and leverage 166 their tax credit potential to stand out from other job seekers and get a job. The job seeker could leverage their LBT, leverage their ‘so close’ status, leverage their knowledge of tax credits, and/or leverage by way of referring others who might be tax credit eligible. Embodiments allow job seekers to leverage this potential with any employer they wish.

In an embodiment, a job seeker gains employment from leveraging their tax credit eligibility. Embodiments incentivize 168 job seekers to find employment via the ‘MyJobBonus’ 168. In this embodiment, ‘MyJobBonus’ 168 refers to any compensation that embodiments provide to job seekers who get a job. This compensation could be in the form of cash, gift cards, points to spend on an embodiment, and/or any incentive to find employment given to a job seeker who might be tax credit eligible. In this embodiment, job seekers find a job using their tax credit potential and an MJC embodiment earns money from the tax credit processing. This contributes to the viral distribution model.

In this embodiment, ‘MyTenureBonus’ 170 depicts an incentive given to a job seeker for maximizing a tax credit for an employer. The actual amount of the tax credit received by an employer is calculated based on the number of hours that an employer works. MyTenureBonus solves the problem of credit eligible job seekers that don't work enough hours at their new employer to earn the employer a tax credit. Embodiments incentivize job seekers to remain employed and maximize their tax credit potential for their employer. This incentive 170 could be in the form of cash, gift cards, points to spend on a plurality of embodiments, etc. In reference to an embodiment that is relative to the Work Opportunity Tax Credit (WOTC), a plurality of embodiments rewards a job seeker with a $20 gift card when the job seeker has worked 120 hours.

At many points, a job seeker might be encouraged to share 172 on social network media and/or third-party sites, etc., about tax credits and/or their success in leveraging tax credit eligibility in gaining employment, etc. In this embodiment, when a job seeker gains employment, they are encouraged to share their success via the previously mentioned, and later discussed in FIG. 2, methods of 200-236. As mentioned in 154, a plurality of embodiments incentivize a plurality of users to share tax credit information by rewarding the job seeker with embodiments of MJC points and/or any other incentive. An embodiment of the points system 174 might be that a job seeker earns two points if they share the tax credit eligibility survey link on social media. Job seekers can redeem 176, 154, etc., these points.

Sharing survey results could bring new users 178 into embodiments of MJC and, in this embodiment, turns the tax credit processing business model into a viral distribution where job seekers invite new users 178 leverage their tax credit potential. New users can join embodiments of MJC and capitalize on their tax credit potential as well. See FIG.

Even if users are already employed, they can continue to leverage their eligibility to find more employment, which embodiments of MJC facilitate, encourages, etc., 180. There is no limit to the amount of employers that can take advantage of a tax credit. Instead of screening for an individual employer, job seekers can utilize their eligibility with any employer they choose and as many employers that they want.

### FIG. 2-200

FIG. 2 is a flowchart that demonstrates an embodiment of how a job seeker connects tax credits with social media or other mass communication forms. The job seeker distributes their tax credit eligibility in applying for employment, connecting with employers, adding tax credit eligibility to a profile on another site, or broadcasting on social media. Other users follow a similar embodiment to share tax credit information, earn points, and redeem the points. In an embodiment of MJC, job seekers are able to select which jobs that would like to apply 202 for at this point. This might be a list of employer users registered with MJC embodiment, and the job seeker will have the option 202 of including their tax credit eligibility information. A job seeker have the option of selecting from a list of employers. The employer receives the results and information regarding the job seekers in their employer profile or in an email or some other communication. Sharing their results with any employer they choose 204 gives the job seeker power over their tax credit eligibility. In embodiment, after selecting from as many employers 204 as the job seeker wishes, the job seeker clicks ‘send’ to send 206 their results. The job seeker can also send their results to any email address 208 they want. This might be an open entry field for the user to express interest in employment at any company with an email address. The user can input as many and whatever email addresses they want (including their own). After inputting email addresses, the user selects ‘send’ to send their results 210 in an embodiment. The job seeker's information and tax credit eligibility information is sent to the email addresses provided.

In this embodiment, another way that a job seeker can share their results is by using their ‘LBT Badge’ 212. In this embodiment, 212 displays the user's tax credit potential on other sites. The ‘LBT Badge’ refers to any transportable, electronically transmissible summation documentation regarding the job seeker's tax credit eligibility 212. See the information described in 138-144.

The badge, or documentation, can be implemented in many embodiments, including, but not limited to: job boards, social networking sites, recruiting applications, ATSs, etc. In this embodiment, the tax credit eligibility badge is added to a social media profile or a job board profile 214. The badge 212 is viewable by other users and indicates tax credit eligibility to prospective employers. See FIG. 3.

The user is presented with the option to authorize the API 216 for an applicable third-party website, and the badge is then transferred to their job seeker profile on the outside website.

The badge, 218, or any form of tax credit eligibility documentation, is displayed on the profile so that prospective employers that use the third-party website can see tax credit eligibility, via 218. In this embodiment, ‘badged’ refers to a person and/or profile and/or account, etc., that displays tax credit information 218 to other users. Alternatively, an embodiment provides a URL, HTML code, widget, other type of code, etc., 220, with which the user can apply to their profile on a site that is not currently a partner of an embodiment of MJC.

The job seeker is presented with a button and/or option, etc., 222, to share their results on social media and/or social network and/or social media messaging and/or other website, etc., that allows mass communication and/or selected communication between users, etc. 224 refers to an embodiment of sharing results on a social media platform. The job seeker allows an embodiment to access the social media site API data transmission, 226.

In one embodiment, the results are shared as a “status update” 228. The results might display the job seeker's credit potential and information about how this can help other users. The status 228 might include a link back to an embodiment of MJC. Other users see this status 228 and can access an embodiment via this viral distribution model.

In another embodiment, the user can choose to broadcast their results using a social media messaging service 230. An example of 230 might be Twitter® or WhatsApp®.

The user can confirm the message 232 that contains their tax credit potential and information about how this can help other users. Other users or recipients receive the information via 232, and can access an embodiment by clicking on or selecting it.

Sharing tax credit potential is not tied to the aforementioned methods and should be considered to reference any sort of publishing, broadcasting, messaging, sharing, any other form of public display of tax credit information, etc.,—any such means 234 for a job seeker can publicly display their tax credit potential.

In this embodiment of accessing third-party sites, the user can return to an embodiment MJC 236.

### FIG. 3-300

FIG. 3 is a flowchart of an embodiment of tax credit screening applied to a job board. Job seekers apply to multiple jobs using tax credit eligibility. Employers receive applications from pre-screened job seekers and browse pre-screened job seekers. An embodiment MJC Employer 1 302—an employer user of the job board that is a client. Employer 1 302 creates a profile 304 online on the job board. Employer 1 posts jobs 306 on the job board that are visible to any job seeker users of the site.

Employer 1 searches the Hiring Pool 308 for job seekers that they are interested in. Just as employers can search for education, skills, etc., they can also search for job seekers based on their tax credit value, 308. More about the Hiring Pool in FIG. 5.

From FIG. 3—When employers receive applications on the job board, the employers are able to see the applicants' tax credit values 310. Applications from job seeker users that have taken the tax credit eligibility survey are “badged” with their tax credit value—“does not qualify”, “so close”, and “high potential”—“Little Blue Ticket”. Employers use the badge system learn tax credit value and use it in the employment decision. “Badge”, “badging”, “badged”, “does not qualify”, “so close”, “high potential”, and “Little Blue Ticket” are terms used by an embodiment for displaying the tax credit eligibility of a pre-screened job seeker; however, it is the function of pre-screening a job seeker, making their tax credit potential available to the job seeker and any employer, and enabling them to leverage this eligibility in applying for any job with any employer that are the important features. Employer 1 302 contacts a job seeker in whom they have interest, whether from the hiring pool or if the job seeker applied for the job on their own. The assumption is that the employer considers the job seeker's “badge” in deciding to interview them 312. Employer 1 decides to hire 314 Job Seeker based on his/her tax credit eligibility.

FIG. 3—As a client, Employer 1's tax credit 316 application is processed by an embodiment. An embodiment calculates 318 the real value of the tax credit based on Job Seeker's wages and hours.

FIG. 3—Job Seeker user 340 of an embodiment MJC job board. Job Seeker 340 creates profile 342 on the job beard. Job Seeker wants to discover his/her tax credit eligibility and chooses to self-screen 344 by taking the survey. Alternatively, a job seeker may import 344 their tax credit eligibility to the job board if they had previously taken an embodiment survey on another job board, an embodiment of an MJC site, Facebook, etc. This simply transfers eligibility to the job seeker's job board profile. Job Seeker has the option of displaying 346 their tax credit eligibility on their user profile and/or their job applications.

Demonstrated in FIG. 3—Job seeker applies 348 to jobs on the job board. Along with standard job application information, the job seeker can include their tax credit eligibility 350. In being contacted by Employer 1 and Employer 2, Job Seeker has leveraged 350 their tax credit eligibility. Employers 1 and 2 consider 350 the tax credit eligibility in choosing to contact Job Seeker and during the interview. Job Seeker gets hired 352 by both Employer 1 and Employer 2. Job Seeker used his/her tax credit eligibility in applying to multiple employers, even though Employer 2 is not a client.

As shown in FIG. 3, Job Seeker receives an incentive 354—MyJobBonus—from an embodiment for getting a job. This could be money, points, etc. As an LBT holder, Job Seeker is rewarded for finding a job, because an embodiment is able to process the tax credit. If Job Seeker maintains employment at MJC Employer 1 for a certain amount of hours (typically 120 OR 400 OR MAX), the Employer 1 is able to maximize their tax credit. Job Seeker is incentivized 356 to stay employed and max out the credit—MyTenureBonus.

As shown in FIG. 3, Employer 2 370 is a job board user that is not a tax credit processing client. Employer 2 uses an MJC job board embodiment in the same manner as Employer 1 until 384. This demonstrates how any internet user accesses an embodiment of MJC—not only tax credit processing clients. Employer 2 370 creates a profile 372 online on the job board. Employer 2 can post jobs 374 on the job board that are visible to any job seeker users of the site. Employer 2 searches 376 the Hiring Pool for job seekers in whom they have interest. Just as employers can search for education, skills, etc., they can also search for job seekers based on their tax credit value. More about the Hiring Pool in FIG. 5.

In FIG. 3, when employers receive badged applications on the job board, the employers are able to see 378 the applicants' tax credit values. Applications from job seeker users that have taken the tax credit eligibility survey are “badged” 378 with their tax credit value—“does not qualify”, “so close”, and “high potential”—“Little Blue Ticket”. Employers can use the badge system learn 378 tax credit value and use it in the employment decision. An embodiment uses a plurality of terms for displaying the tax credit eligibility of a pre-screened job seeker, including—but not limited to—“badge”, “badging”, “badged”, “does not qualify”, “so close”, “high potential”, “Little Blue Ticket”, etc.; however, it is the function of pre-screening a job seeker, making their tax credit potential available to the job seeker and any employer, and enabling them to leverage this eligibility in applying for any job with any employer that are the important features.

In FIG. 3, Employer 2 370 contacts a job seeker in whom they have interest, whether from the Hiring Pool or if the job seeker applied for the job on their own. The assumption is that the employer considers 380 the job seeker's “badge” in deciding to interview 380 them. Employer 2 decides to hire 382 Job Seeker, considering his/her/etc., tax credit eligibility.

As a screening tool, an embodiment does not limit its screening services to tax credit processing clients. User Employer 2 uses a different vendor to process their tax credits. POST JS DATA TO OUTSIDE VENDOR—an embodiment allows Employer 2 to capture Job Seeker's relevant tax credit information and send 384 it to a vendor of Employer 2's choice. PROCESS WITH OTHER VENDOR—Outside vendor processes Employer 2's tax credit 386.

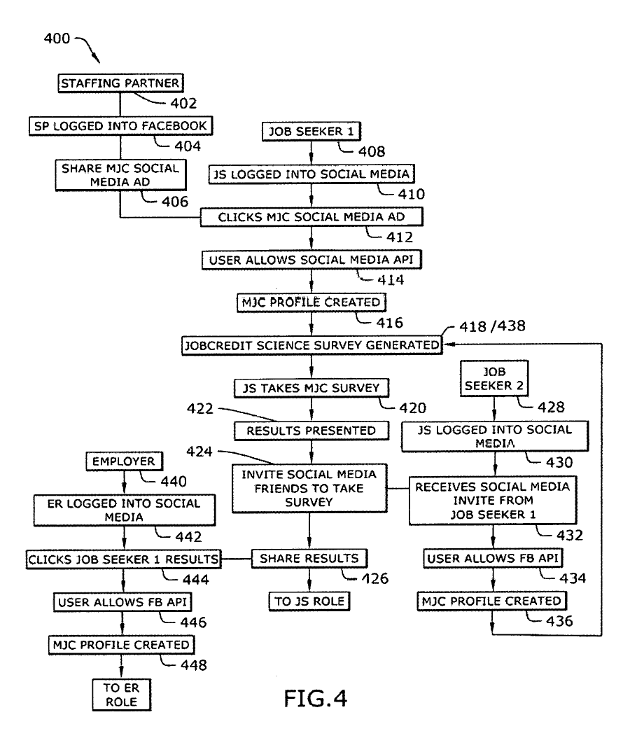

### FIG. 4-400

FIG. 4 is a flowchart of an embodiment of tax credit screening applied to social networking/social media. Referencing Staffing Partner 402—in this embodiment, Staffing Partner may or may not be an existing embodiment user. Staffing Partner 402 is logged into Facebook 404. Staffing Partner 402 shares 406 an MJC embodiment Facebook ad. The ad appears on Staffing Partner Facebook page and appears to other Facebook users, such as Job Seeker 1 408.

Job Seeker 1 408 is not an existing embodiment user; in this embodiment, Job Seeker 1 408 is logged into a social media network, etc., 410. Facebook MJC Social Media Ad communicated 406 by Staffing Partner 402 is available to Jobseeker 1 408, who clicks on MJC Social Media Ad 412. Job Seeker 1 408 accesses an embodiment of MJC via Facebook 412 and allows an embodiment to access Job Seeker 1's Facebook API 414. Accesses Job Seeker 1's profile allows an embodiment to store relevant profile information as JobSeekerDNA, as referenced in FIG. 1 126. By allowing an embodiment access to Job Seeker 1's Facebook API 414, Job Seeker has created an embodiment account, generated by API information, etc., 416. JobCreditScience—as referenced in FIG. 128—produces a customized survey 418/438 according to the JobSeekerDNA 126 obtained from the Job Seeker 1's Facebook API 414. Job Seeker 1 takes the customized qualification survey 420. An embodiment presents Job Seeker 1 408 with their tax credit potential 422 based on the answers they provided in the survey 420. After taking the survey, an embodiment presents 424 Job Seeker 1 408 with the option to invite others to take the survey 424. Job Seeker 1 sends an invite to other people 424 that might qualify for a tax credit. an embodiment presents Job Seeker 1 408 with the option of sharing survey results 426 on Social Media Facebook. Job Seeker 1 shares results 426—other friends might take advantage of tax credits.

Job Seeker 2 428 is or is not an existing user of an MJC embodiment and logs into social media network, etc., 430, receiving social media invite from Job Seeker 1 432. Job Seeker 2 428 allows an embodiment to access Job Seeker 2 Facebook social network API 434: an embodiment creates an embodiment user profile for Job Seeker 2, using information obtained from social media API 436. An embodiment's automated pre-screening JobCreditScience generates a survey for Job Seeker 2 438. Job Seeker 2 may then take similar steps as those described in 418-426.

Employer 440 is not necessarily an embodiment of MJC user in this embodiment. Employer 440 logs into their Facebook account profile, etc.; 442, and clicks 444 on Job Seeker 1 share results 426. Employer 440 authorizes embodiment access to their FB API 446, creating a profile with an embodiment of MJC 448.

### FIG. 5-500

FIG. 5 is a flowchart of an embodiment of employers connecting with pre-screened job seekers via a database. FIG. 5 also demonstrates how the different users connect. An embodiment Staffing Partner user 502 invites Employer 1 to an embodiment 504—via an embodiment GUI or not. Employer 1 receives invite from Staffing Partner 506, and then creates a profile on MJC embodiment 510, in this embodiment. Within an embodiment GUI, Employer 1 512 selects search Hiring Pool, searching for job seeker candidates with tax credit potential. Employer 1 filters a Hiring Pool embodiment search results 514—organizing, identifying, etc., a plurality of information such as highest Credit Amount, lowest Credit Amount, etc. As in traditional recruiting, the Employer 1 can filter or sort based on based on job seeker profile data 516—e.g., job seeker employment history—or job seeker location 518 or educational background 520. In an embodiment, Employer 1 filters based on job seeker badge data 522—referring to job seeker eligibility criteria. An example of job seeker badge 522 might be the type of credit for which job seekers might be eligible. Credit Type 524 refers to a specific type of tax credit for which Employer 1 might search: e.g., the California New Employment Credit. Said California New Employment Credit is a specific credit that an employer might be looking for in order to reduce their state tax liability. By choosing to filter based on the California New Employment Credit, the employer might only be shown applicable job seekers. Another criterion for which Employer 1 might search is Credit Amount 526, referring to the potential dollar amount that a particular job seeker might be worth if they are hired by an employer: e.g., if Employer 1 is looking for a $9,000 credit, a user can select this filter so that only job seekers that are pre-screened for a $9,000 credit are displayed. Credit amounts 526 can be sorted: e.g., from highest amount to lowest amount. Credit amounts 526 can be sought within a specific range: e.g., $4,000-$10,000; only job seekers with credits within this range are displayed—though the aforementioned filter or sort criteria should not be considered exhaustive. Credit Zone 528 refers to the geographic area, credit authority, etc., where the credit is designated: e.g., an employer from New Hampshire might only want to view credits that can be taken against state tax liability. The employer selects New Hampshire as the preferred Credit Zone 528, and only job seekers whose credits apply to state taxes in New Hampshire are displayed. Alternatively, the employer might want a federal tax credit, so the employer selects ‘Federal’ as the desired Credit Zone 528 and a plurality of job seekers with federal credit eligibility are displayed. When Employer 1 has found a job seeker that fits the filter criteria, they can contact said job seeker or a plurality of job seekers 530. A plurality of employers have access to a plurality of job seekers, their tax credit badge information, etc.; a plurality employers can contact a plurality of job seekers, etc.—via the Hiring Pool Database 544 or some other system, network, etc., where a plurality of the aforementioned capabilities are available.

Staffing Partner 502 invites a job seeker 532 using their embodiment profile. Job Seeker 1 receives Staffing Partner invite to an embodiment 534. Job Seeker 1 creates an embodiment profile 536. Job Seeker 1 screens themselves for tax credit eligibility 538. Job Seeker 1's eligibility is determined 540 and Job Seeker 1 elects to have their profile badged with tax credit eligibility 540. Job Seeker 1 elects to enter the hiring pool 542, making their profile and tax credit eligibility available to employers 544.

Employer 2 560 uses the Hiring Pool in the same way as Employer 1. Employer 2 diagram is to show that a plurality of employers access the Hiring Pool and can choose from any job seekers. Instead of being limited to the specific job seekers that an employer brings in to be screened during application, Employer 2 can pursue tax credits from any job seeker via the Hiring Pool—even if a job seeker is already employed by another employer. Employer 2 selects search Hiring Pool 562 from their embodiment profile, searching for job seeker candidates with tax credit potential. Employer 2 filters a Hiring Pool embodiment search results 564—organizing, identifying, etc., a plurality of information such as highest Credit Amount, lowest Credit Amount, etc. As in traditional recruiting, the Employer 2 can filter or sort based on based on job seeker profile data 574—e.g., job seeker employment history, job seeker location 576, or educational background 578, etc. In an embodiment, Employer 2 filters based on job seeker badge data 566—referring to job seeker eligibility criteria. An example of job seeker badge 566 might be the type of credit for which job seekers might be eligible. Credit Type 570 refers to a specific type of tax credit for which Employer 2 might search: e.g., the California New Employment Credit. Said California New Employment Credit is a specific credit that an employer might be looking for in order to reduce their state tax liability. By choosing to filter based on the California New Employment Credit, the employer might only be shown applicable job seekers. Another criterion for which Employer 2 might search is Credit Amount 568, referring to the potential dollar amount that a particular job seeker might be worth if they are hired by an employer: e.g., if Employer 2 is looking for a $9,000 credit, a user can select this filter so that only job seekers that are pre-screened for a $9,000 credit are displayed. Credit amounts 568 can be sorted: e.g., from highest amount to lowest amount. Credit amounts 568 can be sought within a specific range: e.g., $4,000-$10,000; only job seekers with credits within this range are displayed—though the aforementioned filter or sort criteria should not be considered exhaustive. Credit Zone 572 refers to the geographic area, credit authority, etc., where the credit is designated: e.g., an employer from New Hampshire might only want to view credits that can be taken against state tax liability. The employer selects New Hampshire as the preferred Credit Zone 572, and only job seekers whose credits apply to state taxes in New Hampshire are displayed. Alternatively, the employer might want a federal tax credit, so the employer selects ‘Federal’ as the desired Credit Zone 572 and a plurality of job seekers with federal credit eligibility are displayed. When Employer 2 has found a job seeker that fits the filter criteria, they can contact said job seeker or a plurality of job seekers 580. A plurality of employers have access to a plurality of job seekers, their tax credit badge information, etc.; a plurality employers can contact a plurality of job seekers, etc.—via the Hiring Pool Database 544 or some other system, network, etc., where a plurality of the aforementioned capabilities are available.

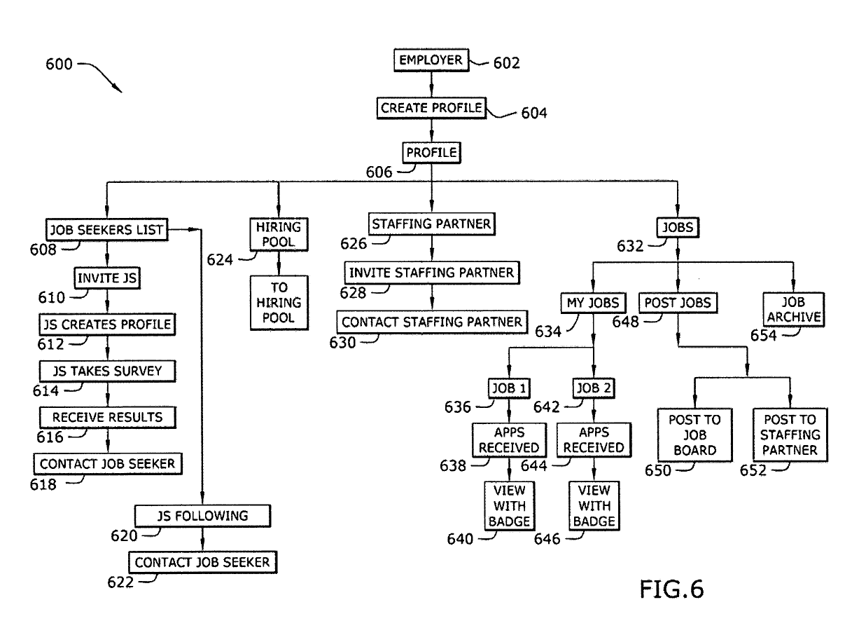

### FIG. 6-600

FIG. 6 is a flowchart of an embodiment of an employer profile. The employer profile is an embodiment of how employers connect with job seekers and staffing partners. A potential employer user visits an embodiment MJC 602, creates a profile 604, and accesses said profile 606. Employer has a profile in this embodiment with MJC features. The profile is similar to a social networking profile in this embodiment. In this embodiment, functions of an embodiment happen from the profile, though features should not be considered to be reliant on a profile.

In this embodiment, the Job Seekers List 608 organizes the job seekers in which the Employer 602 might have interest. Job Seekers are added to the list by the employer inviting them 610 or following them 620; or, by job seekers who apply for—or, express interest in—a job. Job seekers who apply for a job might also appear in the hiring pool 624. Among other criteria, the Job Seekers List displays the job seekers' tax credit badge information. These job seekers can also be marked as ‘employee’ by the employer. After a job seeker is marked as ‘employee’, the tax credit processing system begins. Status updates and action items regarding the processing are communicated to the employer here by an embodiment. Employers invite job seekers to take the tax credit eligibility survey 610 that are not already members of an embodiment. The employer might invite via Facebook or another social network; they can also invite them by manually adding the job seekers' email addresses, by uploading an Excel, CSV-type document containing multiple job seekers, or by connecting to another email service (Outlook, MailChimp, etc.), etc.

Job seekers receive invites by email or a social network, and the jobseekers enter an embodiment and create profile(s) 612. After job seekers create a profile, they take the eligibility survey 614. Employer invites job seekers, because they want the job seekers to screen themselves for tax credit eligibility, apply for the job, etc. Employer receives job seekers' eligibility results 616 in the Job Seeker List, whether invited, following, expressed interested, applied, etc.—in this embodiment. Employer can contact job seekers 618 that they might be interested in interviewing from the job seeker list, considering the job seeker's tax credit potential. In this embodiment, contact can be made by email, phone, integrated messaging, email service, etc. When Employer 602 searches the Hiring Pool 624 and finds job seekers in whom they have interest, Employer ‘Follows’ the job seeker 620 and the job seeker's profile information is saved on the Job Seeker List 608. Job seekers may or may not be notified when they are followed, according to Employer's profile settings—in this embodiment—Employer follows job seekers so that they can be easily compared and contacted 622.

Employer interacts with Staffing Partners from this tab 626. Staffing Partners can arrive on this list by Employer adding them 628, an admin adding them, or by a staffing partner sending their information to Employer. Employer invites staffing partners 628 by either adding their email address or from within a social network profile. Employer invites staffing partners to an embodiment so that they bring in their own job seekers to be screened for tax credit eligibility and the job seekers are referred to Employer. Employer contacts staffing partners 630 from this list via email, integrated messaging, etc.

The Jobs tab 632 organizes Employer's jobs into the following: My Jobs 634, where Employer's active job postings are listed; Post Jobs 648, where Employer can post jobs; and Job Archive 654, where jobs that are no longer active are stored, so that the employer can repost old jobs, use a template, etc. Under My Jobs 634, Job 1 636 is an example of Employer clicking on a specific job they're posted. Employer can view the applications received for this specific job posting 638. The applications contain the job seeker's badge information 640, or lack thereof. Employer can compare the tax credit eligibility 640 of applications while comparing other application data. Job 2 642 is another example of Employer clicking on a specific job posting. Apps Received 644 and View with Badge 646 are further examples of 636-640, as applied to a different job posting. Employer can post jobs 648 to either the job board 650 or to a staffing partner 652. Staffing Partners receive jobs 652 that they can posted with their career center or similar entity.

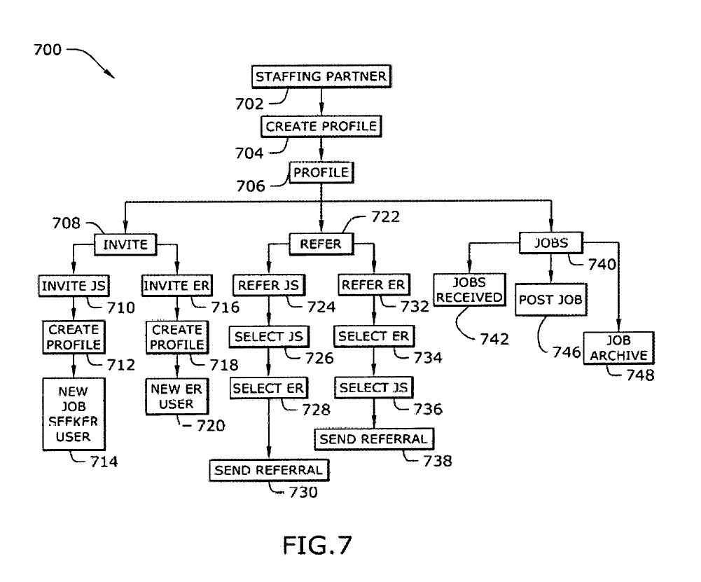

### FIG. 7-700

FIG. 7 is a flowchart of an embodiment of a staffing partner profile. The staffing partner profile is an embodiment of how staffing partners connect with job seekers and employers. Potential Staffing Partner user 702 visits an embodiment and creates profile 704. Staffing Partner accesses their profile 706. In this embodiment, Staffing Partner has a profile with an embodiment features. The profile is similar to a job board, social networking profile, etc. Major functions of an embodiment happen from the profile. An embodiment features should not be considered reliant on a profile.

Staffing Partner user 702 can invite job seekers 710 and employers 716 into an embodiment using this tab. Staffing Partners have job seekers that they want to assist in finding employment. Staffing Partners add their job seekers to this list by email, social network, etc., and send them invitations to join an embodiment to take the eligibility survey. Job seekers receive the invitation and create an embodiment profile 712. Invited job seekers now have access to the job seeker user role 714—as detailed in other figures—with the benefits of a staffing partner aiding their job search by referring job seekers to employers, referring employers to job seekers, etc. Staffing Partners invite employers 716 with whom they wish to work and want to help connect with tax credit eligible job seekers via email, social network, etc. Employers receive the invitation and create an embodiment profile 718. Invited employers now have access to employer user role 720—as detailed in other figures—with the benefits of a staffing partner aiding in their recruitment effort by referring job seekers to employers or referring employers to job seekers.

Staffing Partner refers job seekers 724 and employers 732 to an embodiment via the Refer 722 in this embodiment. Staffing Partners refer their job seekers to employers to help them find employment. Staffing Partner selects the job seeker 726 to whom they wish to send the referral. Staffing Partner selects the employer 728 to whom they wish to refer the job seeker. Staffing Partner confirms to the send referral 730. The job seeker receives a notification alerting them that they should apply to the employer. Staffing Partner refers their employers 732 to job seekers to help their employers fill a position. Staffing Partner selects the employer 734 to whom they want to send the referral. Staffing Partner selects the job seeker that they want to refer to the employer 736. Staffing Partner confirms referral of their job seeker to employer 738.

Jobs are displayed to the Staffing Partner and they organizes their jobs in the Jobs tab 740. Staffing Partner receives job postings from employers here 742. Staffing Partner can post jobs 746 to the job board for their employers. Expired, Saved, Draft jobs are kept in the Job Archive 748 in this embodiment.

### FIG. 8-800

FIG. 8 is several embodiments of how a tax credit screening program informs a job seeker about their tax credit eligibility, advises a job seeker on how to become qualified for a tax credit, and produces documentation for the job seeker to demonstrate their tax credit eligibility. Job Seeker 1 enters an embodiment 802. Job Seeker 1 takes the tax credit eligibility survey 804. Job Seeker 1 did not provide any answers 806 to the survey that would indicate tax credit eligibility. Because Job Seeker 1 did not provide any answers to the survey that would indicate tax credit eligibility, Job Seeker 1 is informed that they do not qualify for a tax credit 808. Job Seeker 1 is informed that their tax credit eligibility may change, and Job Seeker 1 should return and take the survey another time 810. Job Seeker 1 returns to their profile 812.

Job Seeker 2 822 takes the tax credit eligibility survey 824. Job Seeker 2 answers 826 that they have been on SNAP (Food Stamps) for 2 months. Job Seeker 2 confirms that they are 18-39 years old 528, according to information that an embodiment obtained via Job Seeker 2's Facebook profile (see JobSeekerDNA, FIG. 9). According to the answers that Job Seeker 2 provided in the survey, Job Seeker 2 does not currently qualify for a tax credit, but they are informed that they are ‘So Close’ 830 to qualifying. An embodiment advises Job Seeker 2 832 that although they do not currently qualify, they may qualify once they are on SNAP for at least 3 months. An embodiment advises Job Seeker 2 to return and retake the survey in 1 month 832. An embodiment's backend records Job Seeker 2's survey date, along with the survey data that Job Seeker 2 is 1 month away from qualifying for a tax credit 834. An embodiment has a timer that counts down to Job Seeker 2's tax credit eligibility. Approximately 1 month after Job Seeker 2 took the survey, an embodiment automatically sends a reminder email 536 to Job Seeker 2 to take the survey and see if they qualify for a tax credit. Until Job Seeker 2 returns and takes the survey again, an embodiment automatically sends a reminder email to Job Seeker 2 weekly 536. Responding to the reminder emails, Job Seeker 1 returns to their profile to take the eligibility survey 538.

Job Seeker 3 842 takes the tax credit eligibility survey 844. Job Seeker 3 answers that he/she has been on SNAP (food stamps) for 5 months 846. Job Seeker 3 confirms that they are over 39 years old 848, according to information that an embodiment obtained via Job Seeker 3's Facebook profile (see JobSeekerDNA, FIG. 9). According to the answers that Job Seeker 3 provided in the survey, Job Seeker 2 does not currently qualify for a tax credit, but an embodiment informs them that they are ‘So Close’ to qualifying 850. An embodiment advises Job Seeker 3 that they don't currently qualify for a tax credit 852. However, because SNAP credit eligibility is based on household, an embodiment advises Job Seeker 3 that other members of Job Seeker 3's family may for tax credits 852. Job Seeker 3 invites family member to take the qualification survey 854.

Job Seeker 4 enters embodiment 862. Using a location identifier, embodiment determines that Job Seeker 4 is located in an Empowerment Zone 864. Job Seeker 4 takes the tax credit eligibility survey 866. Job Seeker 4 answers that they are between the ages of 18 and 39 years old 868. Because Job Seeker 4 lives in an Empowerment Zone, Job Seeker 4 is given a Little Blue Ticket 870 and informed 872 that they qualify their next employer for up to $2,400 in tax credits. Job Seeker 4 is advised to take the LBT to their next interview and leverage their tax credit value. Job Seeker 4 is also given the option of downloading the LBT, sending it to one of the employer users or entering email addresses to send it to. Because the Empowerment Zone Job is a geographic area, Job Seeker 4 is advised that other members of their household aged 18-39 qualify for a tax credit; also, Job Seeker 4 is encouraged to let others in the Empowerment Zone know that they might qualify for a tax credit. Job Seeker 4 is encouraged to invite others via Facebook and share the survey on Twitter, etc. Job Seeker 4 leverages LBT to get a job, invites family member to take survey, etc., 874.

### FIG. 9-900

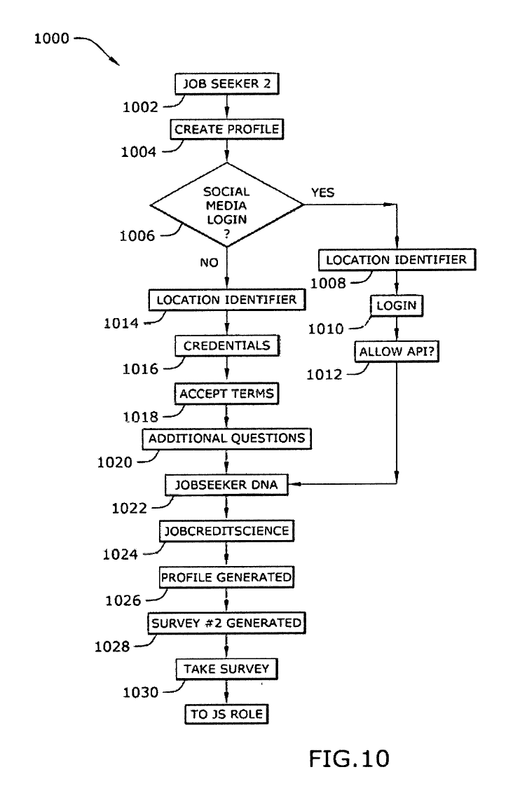

FIG. 9 and FIG. 10 are embodiments of how a tax credit screening system produces customized surveys based on the job seeker's information, whether it is accessed from social media or social networking or location identifier or other means. Job Seeker 1 enters an embodiment 902. Job Seeker 1 selects ‘Create a Profile’ 904 from an embodiment homepage. On the Create a Profile page, Job Seeker 1 is asked if they would like to login with Facebook, social network, etc., 906. If logging-in with social media network, an embodiment asks Job Seeker 1 to use GPS location identifier to determine Job Seeker 1's location and transfer this information to Job Seeker 1's profile 908. Job Seeker 1 is taken to Facebook, etc., and logins into their Facebook account, etc., 910. Job Seeker 1 allows 912 an embodiment to access their Facebook API. If not logging-in with social media network, Job Seeker 1 is asked to use GPS location identifier to determine Job Seeker 1's location and transfer this information to Job Seeker 1's profile 914. Job Seeker 1 creates login credentials: username, password, first/last name, etc., 916. Job Seeker 1 accepts an embodiment Terms & Conditions 918 in accessing the site. Job Seeker 1 is asked some additional questions 920, since they denied the location identifier and social media login in order to inform JobSeekerDNA. This data might include city, state, age, gender, etc. an embodiment collects data for JobSeekerDNA 922. JobSeekerDNA is the relevant information that might be used by JobCreditScience 924 in order to customize the survey. This might be the job seeker's age, location, gender, education level, employment history, likes, interests—anything accessible from a job seeker's social network profile. Based on the JobSeekerDNA, an embodiment uses JobCreditScience 924 to automatically generate Job Seeker 1's profile. Job Seeker 1's education and employment history, profile picture, etc., are transferred to his an embodiment profile 926. Based on the JobSeekerDNA, an embodiment uses JobCreditScience to automatically generate 928 a customized the survey. This survey is unique to Job Seeker 1: e.g., according to his Facebook profile, Job Seeker 1 is a 20 year old male that lives in an Empowerment Zone. JobCreditScience produces a survey that already knows that he qualifies for at least $2,400, so the survey skips those questions and focuses on trying to make Job Seeker 1 qualify for even more credit. The survey also has videos on the side to help Job Seeker 1, and the videos are of a young, attractive female. Job Seeker 1 takes Survey 1 930, uniquely generated for him.

### FIG. 10-1000

FIG. 9 and FIG. 10 are embodiments of how a tax credit screening system produces customized surveys based on the job seeker's information, whether it is accessed from social media or social networking or location identifier or other means. Job Seeker 2 1002 enters an embodiment and selects ‘Create a Profile’ 1004 from the an embodiment homepage. On the Create a Profile page, Job Seeker 2 is asked if they would like to login with Facebook social network 1006. After choosing to login with social media, an embodiment asks Job Seeker 2 to use GPS location identifier to determine Job Seeker 1's location and transfer this information to Job Seeker 1's profile 1008. Job Seeker 2 is taken to Facebook, etc., and logins into their Facebook account 1010. Job Seeker 2 allows an embodiment to access their Facebook API 1012. When not using social media, Job Seeker 2 is asked to use GPS location identifier to determine Job Seeker 2's location and transfer this information to Job Seeker 2's profile 1014. Job Seeker 2 creates login credentials 1016: username, password, first, last name, etc. Job Seeker 2 accepts 1018 an embodiment network Terms & Conditions. Job Seeker 2 is asked some additional questions 1020 if they denied the location identifier and social media login in order to inform JobSeekerDNA 1022. This data might include city, state, age, gender, etc. an embodiment collects data for JobSeekerDNA 1022. JobSeekerDNA is the relevant information 1022 that might be used by JobCreditScience 1024 in order to customize the survey 1028. This might be the job seeker's age, location, gender, education level, employment history, likes, interests—anything accessible from a job seeker's social network profile, etc. Based on the JobSeekerDNA 1022, an embodiment uses JobCreditScience 1024 to automatically generate Job Seeker 2's profile. Job Seeker 2's education and employment history, profile picture, etc., are transferred to his an embodiment profile. Based on the JobSeekerDNA, an embodiment uses JobCreditScience to automatically generate a customized the survey. This survey is unique to Job Seeker 2 1028: e.g., according to his Facebook profile, Job Seeker 2 is a 40-year-old female. JobCreditScience produces a survey that already knows that he qualifies for at least $2,400, so the survey skips those questions and focuses on trying to make Job Seeker 2 qualify for even more credit. The survey also has videos on the side to help Job Seeker 2, and the videos are of a middle aged, attractive male. Job Seeker 2 takes survey 2, uniquely generated for her 1030.

1. (canceled)

2. (canceled)

3. (canceled)

4. (canceled)

5. (canceled)

6. (canceled)

7. (canceled)

8. A screening system comprising:
A tax credit determination program wherein a plurality of job seekers initiate said determination program, whether or not a plurality of employers requested said plurality of job seekers to access said determination program

9. A method of documenting tax credit eligibility:
Providing an indicator of tax credit eligibility to a plurality of job seekers, allowing said plurality of job seekers to demonstrate tax credit eligibility to a plurality of employers

10. A candidate database comprising:
A plurality of job seekers with tax credit documentation accessible to a plurality of employers, whether or not said plurality of employers are a tax credit processing client
